(19) United States
(12) Patent Application Publication
(10) Pub. No.: US 2024/0165640 A1
(43) Pub. Date: May 23, 2024

(54) SPRAY FOUNTAIN CAPABLE OF SPRAYING WATER IN MULTIPLE DIRECTIONS

(71) Applicant: Huizhou Licheng Inflatable Toys Product Co.,Ltd., Huizhou (CN)

(72) Inventor: Tianxing Zhang, Nanchong (CN)

(21) Appl. No.: 18/058,713

(22) Filed: Nov. 23, 2022

(51) Int. Cl. B05B 1/26; B05B 15/62; B05B 15/65

(52) U.S. Cl. CPC B05B 1/267; B05B 15/62; B05B 15/65

(57) ABSTRACT

The present disclosure provides a spray fountain capable of spraying water in multiple directions, which includes: a bottom surface, a water storage ring arranged on an outer edge of the bottom surface, a plurality of water spraying nozzles arranged on a top portion of the water storage ring and spaced apart from each other, and a water inlet member arranged on the top portion of the water storage ring, wherein the water spraying nozzle includes a base and a water spraying head arranged on the base, the water spraying head is hollow and a bottom of the water spraying head defines an opening extended through the base, a side of the water spraying head defines a plurality of water spraying holes arranged in different directions and spaced apart from each other.

### TECHNICAL FIELD

The present disclosure relates to the technical field of spray fountains, in particular to a spray fountain capable of spraying water in multiple directions.

### BACKGROUND

With the improvement of living standard, people pay more attention to the construction of environmental beauty, so they built spray fountains in the city squares, in the parks of factories and schools, and in the family gardens. At present, the spray fountains have some problems. For example, the existed spray fountains generally have several fixed water spraying nozzles, and the water from the water spraying nozzles may be sprayed disorderly due to the influence of the water pressure of the water inlet pipe.

### SUMMARY

In view of the above deficiency, the present disclosure provides a technical solution that can solve the above problem.

A spray fountain capable of spraying water in multiple directions includes: a bottom surface, a water storage ring arranged on an outer edge of the bottom surface, a plurality of water spraying nozzles arranged on a top portion of the water storage ring and spaced apart from each other, and a water inlet member arranged on the top portion of the water storage ring, wherein the water spraying nozzle includes a base and a water spraying head arranged on the base, the water spraying head is hollow and a bottom of the water spraying head defines an opening extended through the base, a side of the water spraying head defines a plurality of water spraying holes arranged in different directions and spaced apart from each other.

Preferably, the bottom surface is circular.

Preferably, the water storage ring is ring shaped.

Preferably, the water spraying head is hemispheric shaped.

Preferably, the water spraying hole extends vertically upwards.

Preferably, the water spraying hole extends obliquely.

Preferably, an oblique angle of the water spraying hole is 45°, or 30°.

Preferably, the water inlet member includes a water inlet section communicated with the water storage ring, a screw thread member is sleeved around an outer surface of the water inlet section, the screw thread member is internally provided with an inner thread.

Preferably, an outer surface of the screw thread member is formed with a plurality of anti-slip protrusions spaced apart from each other.

Compared with the prior art, the present disclosure has the following advantages: the spray fountain capable of spraying water in multiple directions of the present disclosure includes a base and a water spraying head; the water spraying head defines a plurality of water spraying holes arranged in different directions and spaced apart from each other, so that the spray fountain can spray water in different directions. Therefore, the spray fountain has a better ornamental value. The water spraying holes are fine, so as to avoid spraying water disorderly due to the influence of different water pressures of the water inlet.

The additional aspects and advantages of the present disclosure are given in part in the following description, and another part will become apparent from the description below or will be learned through the practice of the present disclosure.

### BRIEF DESCRIPTION OF THE DRAWINGS

The technical solutions of the embodiments of the present disclosure will be clearly and completely described in the following with reference to the accompanying drawings. It is obvious that the embodiments to be described are only a part rather than all of the embodiments of the present disclosure. All other embodiments obtained by persons skilled in the art based on the embodiments of the present invention without creative efforts shall fall within the protection scope of the present invention.

FIG. 1 is a structure diagram of the spray fountain of the present disclosure.

FIG. 2 is a structure diagram of a water spraying nozzle of the spray fountain of FIG. 1.

FIG. 3 is another structure diagram of the water spraying nozzle of the spray fountain of FIG. 1.

FIG. 4 is a structure diagram of a water inlet member of the spray fountain of FIG. 1.

In the figures: bottom surface 1; water storage ring 2; water spraying nozzle 3; water inlet member 4; base 5; water spraying head 6; water spraying hole 7; water inlet section 8; screw thread member 9; inner thread 10; anti-slip protrusion 11.

### DETAILED DESCRIPTION OF THE EMBODIMENTS

The technical solutions of the embodiments of the present disclosure will be clearly and completely described in the following with reference to the accompanying drawings. It is obvious that the embodiments to be described are only a part rather than all of the embodiments of the present disclosure. All other embodiments obtained by persons skilled in the art based on the embodiments of the present invention without creative efforts shall fall within the protection scope of the present invention.

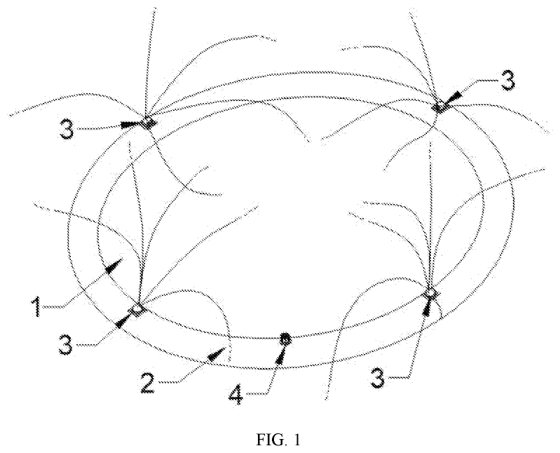

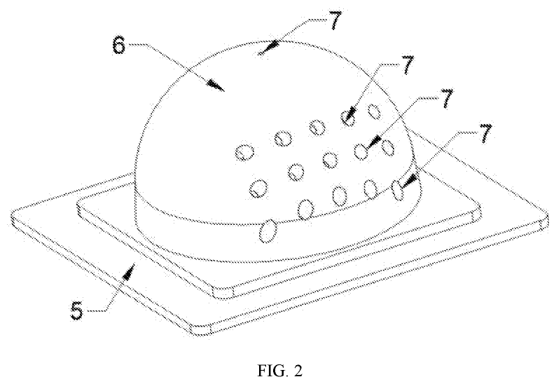

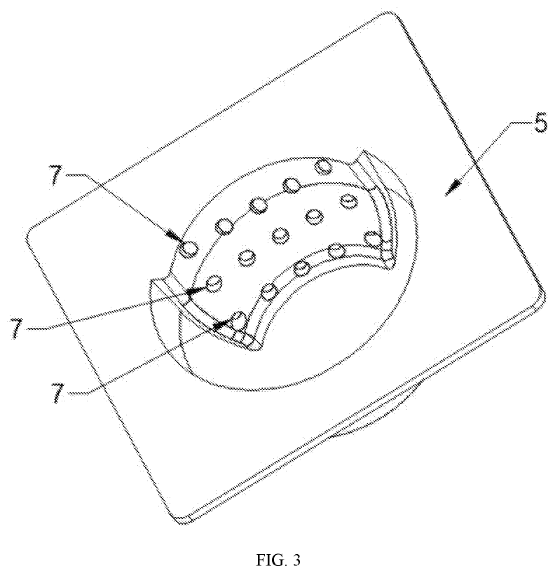

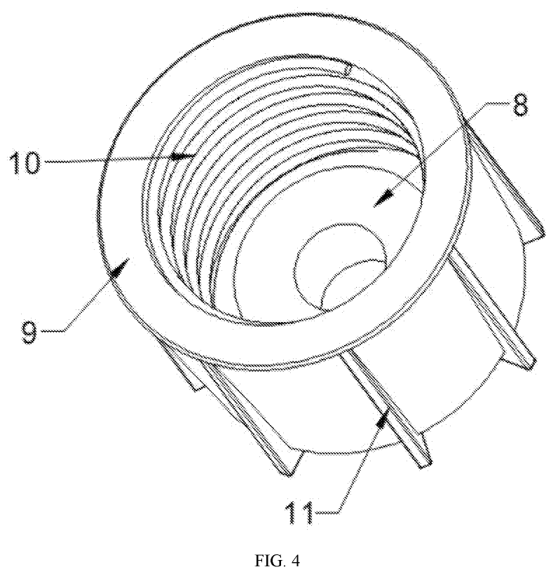

Please referring to FIGS. 1-4, an embodiment of the present disclosure provides a spray fountain which can spray water in multiple directions. The spray fountain includes a circular bottom surface 1, an outer edge of the bottom surface 1 is formed with a water storage ring 2 which is ring shaped, a top portion of the water storage ring 2 is provided with a plurality of water spraying nozzles 3 spaced apart from each other, the top portion of the water storage ring 2 is further provided with a water inlet member 4, the water spraying nozzle 3 includes a base 5, and a hemispheric water spraying head 6 arranged on the base 5, the water spraying head 6 is hollow and a bottom of the water spraying head 6 defines an opening which extends through the base 5, a side of the water spraying head 6 defines a plurality of water spraying holes 7 arranged in different directions and spaced apart from each other.

Preferably, the water spraying hole 7 extends vertically upwards, or the water spraying hole 7 extends obliquely, and an oblique angle of the water spraying hole 7 is 45°, or 30°.

Preferably, the water inlet member 4 includes a water inlet section 8 that is communicated with the water storage ring 2. A screw thread member 9 is sleeved around an outer surface of the water inlet section 8. An inner surface of the screw thread member 9 is formed with an inner thread 10.

Preferably, an outer surface of the screw thread member 9 is formed with a plurality of anti-slip protrusions 11 spaced apart from each other.

The foregoing descriptions are merely specific implementation manners of the present application, but are not intended to limit the protection scope of the present application. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A spray fountain capable of spraying water in multiple directions, comprising:
a bottom surface;
a water storage ring, arranged on an outer edge of the bottom surface;
a plurality of water spraying nozzles, arranged on a top portion of the water storage ring and spaced apart from each other; and
a water inlet member, arranged on the top portion of the water storage ring, wherein
the water spraying nozzle comprises a base and a water spraying head arranged on the base, the water spraying head is hollow and a bottom of the water spraying head defines an opening extended through the base, a side of the water spraying head defines a plurality of water spraying holes arranged in different directions and spaced apart from each other.

2. The spray fountain of claim 1, wherein the bottom surface is circular.

3. The spray fountain of claim 1, wherein the water storage ring is ring shaped.

4. The spray fountain of claim 1, wherein the water spraying head is hemispheric shaped.

5. The spray fountain of claim 1, wherein the water spraying hole extends vertically upwards.

6. The spray fountain of claim 1, wherein the water spraying hole extends obliquely.

7. The spray fountain of claim 6, wherein an oblique angle of the water spraying hole is 45°, or 30°.

8. The spray fountain of claim 1, wherein the water inlet member comprises a water inlet section communicated with the water storage ring, a screw thread member is sleeved around an outer surface of the water inlet section, the screw thread member is internally provided with an inner thread.

9. The spray fountain of claim 8, wherein an outer surface of the screw thread member is formed with a plurality of anti-slip protrusions spaced apart from each other.
